(19) United States
(12) Patent Application Publication
(10) Pub. No.: US 2026/0084080 A1
(43) Pub. Date: Mar. 26, 2026

(54) METHOD, APPARATUS, AND SYSTEM TO OPTIMIZE FLOCCULATION OF SOLID PARTICLES IN A SETTLING VESSEL

(71) Applicant: ClearStream Environmental, Inc., Sandy, UT (US)

(72) Inventors: Jerold Lorenzo Johnson, Holladay, UT (US); Jeffery H. Easton, Cottonwood Heights, UT (US); Jared Darwin Sorensen, Riverton, UT (US)

(21) Appl. No.: 18/891,324

(22) Filed: Sep. 20, 2024

(51) Int. Cl. B01D 21/24; B01D 21/00; B01D 21/01; B01F 25/00; B01F 25/42; B01F 101/00; C02F 1/52

(52) U.S. Cl. CPC B01D 21/2422; B01D 21/0042; B01D 21/01; B01F 25/42; C02F 1/52; B01F 2025/915; B01F 2101/305; C02F 2201/002; C02F 2301/026

(57) ABSTRACT

A system for optimizing flocculation in a liquid waste settling vessel is disclosed having outlet configured to propagate a slurry feed stream flow into a feedwell in a downward direction. A deflector is disposed beneath the feedline outlet. The deflector is configured to intercept the slurry feed stream flow and direct the slurry feed stream in a fan-like shape toward the outer wall of the feedwell where the flow will separate into an upward portion and a downward portion. The upward portion helps create a first mixing zone above the deflector. The downward portion helps create a second mixing zone beneath the deflector.

### FIELD OF THE TECHNOLOGY

This application generally relates to the field of wastewater management, mineral processing and particularly to the optimization of flocculation of solid particles in liquid waste streams for dewatering purposes.

### BACKGROUND OF THE TECHNOLOGY

The dewatering of wastewater slurry, a liquid containing solids, is critical to any process using slurry to transfer solids from stage to stage. The dewatering is often accomplished in a settling vessel comprising a feedwell. The recovery of solids from the settling vessel is used for downstream operations. Examples of downstream operations include, but are not limited to, tailing storage, filter feed, autoclave feed, and next CCD stage. One method to separate the solids is to flocculate the solids, producing a conglomerate of particles (i.e., floccules) that effectively produce quicker settling due to their size. The settling floccules are discharged from a discharge outlet and the clarified water is discharged through a trough or other collection device (sometimes referred to as a launder) at the top of the vessel. The flocculation of the solids occurs in the feedwell which is in fluid communication with the settling vessel. Current feedwell designs are deficient in that the delivery of feed slurry to the feedwell results in a short circuit in the mixing process resulting in premature exiting of the solids from the feedwell resulting in inefficient settling and poor overflow clarity. Other deficiencies include the plugging of feedwell delivery components with solid particles. The present technology overcomes those deficiencies through the improvements noted herein.

### BRIEF DESCRIPTION OF THE DRAWINGS

Various aspects of the present technology will become more fully apparent from the following description and appended claims, taken in conjunction with the accompanying drawings. Understanding that these drawings merely depict exemplary aspects of the present technology, they are therefore not to be considered limiting of its scope. It will be readily appreciated that the components of the present technology, as generally described and illustrated in the figures herein, could be arranged and designed in a wide variety of different configurations. Nonetheless, the technology will be described and explained with additional specificity and detail through the use of the accompanying drawings in which:

FIG. 1 is a perspective view of a portion of a settling vessel and feedwell in accordance with one aspect of the technology;

FIG. 2 is a side view of a portion of settling vessel and feedwell in accordance with one aspect of the technology;

FIG. 3A is a view of a deflector and slurry feed pipes in accordance with one aspect of the technology;

FIG. 3B is a side view of a portion of FIG. 3A;

FIG. 4 is a view of a deflector and slurry feed pipes in accordance with one aspect of the technology;

FIG. 5 is a top view of a feedwell in accordance with one aspect of the technology; and

FIG. 6 is a view of a portion of a deflector and slurry feed pipe in accordance with one aspect of the technology.

### DETAILED DESCRIPTION

The following detailed description of exemplary aspects of the technology refers to the accompanying drawings, which form a part hereof and in which are shown, by way of illustration, exemplary aspects in which the technology may be practiced. While these exemplary aspects are described in sufficient detail to enable those skilled in the art to practice the technology, it should be understood that other aspects may be realized and that various changes to the technology may be made without departing from the spirit and scope of the present technology. Thus, the following more detailed description of the aspects of the present technology is not intended to limit the scope of the technology, as claimed, but is presented for purposes of illustration only and not limitation to describe the features and characteristics of the present technology and to sufficiently enable one skilled in the art to practice the technology. Accordingly, the scope of the present technology is to be defined solely by the appended claims.

As used in this specification and the appended claims, the singular forms “a,” “an” and “the” include plural referents unless the context clearly dictates otherwise. Thus, for example, reference to “a line” includes a plurality of such lines. In this disclosure, “comprises,” “comprising,” “containing” and “having” and the like can have the meaning ascribed to them in U.S. Patent law and can mean “includes,” “including,” and the like, and are generally interpreted to be open ended terms.

The terms “first,” “second,” “third,” “fourth,” and the like in the description and in the claims, if any, are used for distinguishing between similar elements and not necessarily for describing a particular sequential or chronological order. It is to be understood that any terms so used are interchangeable under appropriate circumstances such that the embodiments described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments described herein are, for example, capable of operation in other orientations than those illustrated or otherwise described herein. The term “coupled,” as used herein, is defined as directly or indirectly connected in any manner. Objects described herein as being “adjacent to” each other may be in physical contact with each other or in close proximity to each other as appropriate for the context in which the phrase is used. Occurrences of the phrase “in one embodiment,” or “in one aspect,” herein do not necessarily all refer to the same embodiment or aspect.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, the term “about” is used to provide flexibility to a numerical range endpoint by providing that a given value may be “a little above” or “a little below” the endpoint. Unless otherwise stated, use of the term “about” in accordance with a specific number or numerical range should also be understood to provide support for such numerical terms or range without the term “about”.

The term “feed slurry” refers to the liquid waste (including, for example, municipal wastewater or mineral processing) feed stream that is propagated into the feedwell. The term “feedwell slurry” refers to the mixture of fluids and solids that is in the feedwell and subject to the mixing processes of the feedwell.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Reference throughout this specification to “an example” means that a particular feature, structure, or characteristic described in connection with the example is included in at least one embodiment. Thus, appearances of the phrase “in an example” in various places throughout this specification are not necessarily all referring to the same embodiment.

### Example Embodiments

It should be understood that the aspects of the technology discussed herein are contemplated for use with liquid waste with some solid component (e.g., municipal waste, mineral processing, industrial waste, etc.) treatment systems, apparatus, and methods of using the same. For purposes of illustrating the various aspects of the methods and systems claimed herein, the discussion below will be primarily directed to describing exemplary embodiments directed to an improved system, method or apparatus with a feedwell structure optimized to more efficiently deliver feed slurry to a feedwell and resulting in optimized mixing with the feedwell slurry. The term wastewater is used broadly to refer to any liquid waste stream where it is desirable to reduce the solids through a dewatering process. It should be noted, however, that the elements and principles discussed herein are applicable to other applications. It is also noted that discussion of methods and systems herein can be interchangeable with respect to specific aspects. In other words, a specific discussion of one method, apparatus, or system (or components thereof) herein is equally applicable to other aspects as they relate to the system, method, or apparatuses and vice versa.

An initial overview of technology embodiments is provided below and specific technology embodiments are then described in further detail. This initial summary is intended to aid readers in understanding the technology more quickly but is not intended to identify key or essential technological features, nor is it intended to limit the scope of the claimed subject matter. In particular, certain aspects of the technology are directed towards an apparatus, systems, and methods of optimizing feedwell mixing comprising a feedwell configured to receive liquid waste feed from a feed line. A flocculant (e.g., a flocculant) is added to the liquid waste feed to build floccules for settling.

Generally speaking, the feedline comprises an outlet configured to propagate a slurry feed stream flow into the feedwell in a downward direction. A deflector disposed beneath the feedline outlet concentric around a center line of the feedwell. In one aspect, the deflector is generally cone shaped (i.e., it has a downward sloping top surface) with an outer edge of the cone being disposed beneath a top of the cone. The deflector is configured to intercept the slurry feed stream flow and direct the slurry feed stream in a fan-like shape toward the outer wall of the feedwell where, when the deflector is submerged beneath the feedwell slurry, the flow will separate into an upward portion and a downward portion. The upward portion helps create a first mixing zone above the deflector. The downward portion helps create a second mixing zone beneath the deflector. A flocculant is added to the feedwell

In one aspect of the technology, a wastewater feedwell is in fluid communication with a settling vessel. The feedwell is used to flocculate solids in the wastewater for settling in the vessel. The feedwell is sometimes referred to as a thickener or clarifier which comprises overflow launder(s) at the top of the vessel to collect clarified water. The vessel also comprises an underflow nozzle(s) or outlet located near the bottom of the vessel to discharge a volume of settled solids. Generally speaking, the feedwell functions to optimize conditions so that the solids may settle. In one aspect, this is accomplished by moderating the feed slurry flow which often times comprises a high enough flow rate to keep the solids suspended in the slurry while permitting downward flow of solids leaving the feedwell at a slow velocity. This slow velocity permits the floccules to settle and be collected in the vessel lower area. Generally speaking, flocculation requires three components: 1) an appropriate flocculant type, 2) a proper flocculant dosage, and 3) mixing. These components are interrelated where changes in one can affect change in the other two components. Meaning, if the mixing changes intensity or duration it will affect the required dosage of flocculant needed to induce particles to stick together. A mixing intensity that is too mild or too strong may limit the proper development of the floccules which would increase the dosage required.

In certain aspects of the technology, the mixing is provided by the feed stream momentum entering the feedwell. This can be done when the outlet of the feed slurry stream disposed above the feedwell slurry level or, alternatively, with the outlet of the feed slurry stream submerged within the feedwell slurry. With the feed flow gradually slowing as it circulates within the feedwell, an optimum mixing is achieved in a portion of the feedwell volume where the feed flow velocity has the energy to cause efficient flocculation of the solids.

Aspects of the technology addresses feedwell problems (e.g., short circuiting and limited volume with optimal mixing for flocculation, etc.) through the use of a single stage feedwell. The use of a single stage eliminates problems resulting from the plugging of the port(s) that communicate between first and second stages. Certain aspects of the technology manage the blending of the solids inflow which can enter the feedwell submerged in the feedwell slurry. Density differences between the feed slurry and the feedwell slurry allows the feed slurry flow to drift downward. Advantageously, aspects of the technology optimize downward component migration so solids do not exit the feedwell without time needed for proper flocculation.

In one aspect of the technology, a centrally fed feed stream is used. The feed is transported to approximately the center of the settling vessel. In one aspect of the technology, the feed is directed generally in a downward direction into a single stage feedwell. While the feed pipe may be oriented in a direction that is parallel with a direction of gravity, it is understood that the feed pipe may be oriented in any direction so long as the slurry feed flow contacts the defector in a generally downward orientation. As the slurry feed flow exits the feed pipe in a downward direction, it flows into the feedwell and contacts a deflector. The deflector intercepts the downward feed flow and directs it to have an outward “fanning” shape. In other words, as the feed flow contacts the defector and flows down a top surface of the deflector, the width of the slurry feed flow on the deflector increases or “fans out” in a generally triangular or trapezoidal shape.

In one aspect of the technology, the deflector is separate from the feed pipe but can be mounted on the pipe, maintaining spacing for proper feed flow contact. The deflector has a surface area large enough to receive and direct the full slurry feed flow. The deflector intercepts the full slurry feed flow, preventing the flow from prematurely leaving the feedwell. In other words, it minimizes feedwell short circuiting which can be created by downward slurry momentum induced by a general downwardly oriented slurry feed flow as well as downward slurry drift in inefficient horizontally oriented slurry feed flows, including those oriented tangential to the feedwell.

Mixing limitations of other feedwells is lessened by having the slurry feed flow travel to and contact the feedwell wall at a relatively constant velocity. The flow of the feed stream widens as it is deflected by the deflector, giving a wider area when the flow reaches the feedwell wall thus, giving uniform mixing for the full stream.

In addition, the use of a two stage feedwell requires the feed to communicate between the two stages through small ports that can plug, this new technology takes advantage of the fanning flow toward the feedwell wall in a single stage without using small ports prone to plug. Unlike two-stage systems that may need a driving head in the chamber to give the mixing momentum through their ports, aspects of the technology achieve the same target velocity entering the feedwell with the feed flow velocity but without the need for two stages.

Another benefit of directing the feed flow to the feedwell wall is the ability to have relatively steady mixing intensity in a larger area than existing feedwells. Improving the mixing used for flocculation effectively reduces the dosage requirement. The widening of the slurry feed stream when contacting the deflector also provides a wide area of flow that contacts the feedwell wall. The mixing intensity over a wider area at the wall increases the relatively consistent mixing zone.

In one aspect of the technology, the feedwell comprises a shelf that extends inward from the feedwell outer wall. The shelf size allows proper open area to communicate the feedwell with the settling vessel at the design slow exit velocity flow into the settling vessel. In one aspect, the shelf can be 90° or more measured from vertical feedwell wall. When the radial flow contacts the feedwell outer wall, the flow is split with a portion directed vertically up the wall and a portion directed downward along the wall. The flow upward generally reaches the feedwell slurry surface causing a mild surface disturbance and recirculates toward the center of the feedwell. The portion of the recirculating flow can combine with the new slurry feed flow where any solids left in the recirculating flow could be collected in the mix zone. The flow directed down the wall will contact the feedwell shelf sending a portion of the flow toward the center causing a recirculating flow pattern with part of the flow rising up into the path of the radial feed flow. These flow patterns create circulation movement around a large portion of the feedwell volume driven by the radial flow momentum, the shape of the deflector and feedwell. The circulation often brings a volume back into the optimum mixing zone to collect (flocculate) additional particles that may be in the flow.

In another aspect of the technology, the slurry feed stream is split into more than one pipe or channel before it enters the feedwell, the flow from each is directed in a downward direction and enters the feedwell directly. The flow from each slurry feed pipe is intercepted by one or more deflectors. In one aspect, the deflector can be in the shape of a cone located approximately in the center and concentric to the feedwell. The deflector directs each flow mainly toward the feedwell wall. In another aspect, the deflector is a cone, either inverted (sloping up toward the feedwell wall) or converted (sloping down toward the feedwell wall).

In another aspect, the deflector can have multiple angles measured from the horizontal that transition radially. For example, a deflector inner area could have a steeper slope with a shallower slope in the middle and a shallow angle near the outer edge. The slope is measured from the horizontal.

In one aspect of the technology, the slope of the top of the deflector ranges from about 20 degrees to about 50 degrees, though in other aspects the slope ranges from about 30 to about 45 degrees. In one aspect of the technology the slope of the top of the deflector is continuous but in other aspects the slope is discontinuous. Meaning, in a first section nearest the feed slurry outlet, the slope of the deflector ranges from 40 to 50 degrees. As the defector extends outward towards the outer wall, the slope decreases. In this example, in a second section, the slope ranges from about 30 to 40 degrees, a third section ranges from about 15 to 30, and a fourth section ranges from about near zero to about 15 degrees. The above aspects are examples only and it is understood that different slopes and different numbers of sections may be used as suits a particular design.

In one aspect of the technology, the defector is constructed from materials that are dictated by the type of slurry feed flow anticipated. For example, if the slurry feed is acidic an alloy (e.g., steel) that is resistant to corrosion would be used. In other aspects, a top surface of the deflector comprises a material intended to reduce abrasive wear such as rubber, ceramic tiles, or alloys.

In one aspect of the technology, the feed pipe flow rate is used to keep the solids suspended. In one aspect, that flow rate ranges from about 1 to about 2 meters/sec. In one aspect of the technology, the flow slows from the deflector to the outer wall of the feedwell. The velocity decreases, however, as it contacts the outer wall and travels through the feedwell slurry, either above the deflector or below the deflector. Generally speaking, the distance from the flow entrance into the feedwell to the feedwell wall determines the velocity. In one aspect of the technology, the target velocity of the feedwell slurry in the mixing zone about the feedwell wall ranges between 0.1 - 0.3 m/s. Feedwell sizing determines these target velocities. The velocity of the circulation flow rate below the deflector ranges from about 0.05 to about 0.1 m/s.

In another aspect of the technology, the slurry feed pipe is angled toward the deflector in a degree less than 90° measured from the surface of the deflector. The angled pipe directs the flow to contact the deflector with a less than directly downward component, which aids in the transition to the desired fanned flow. In yet another aspect, one or more baffles are provided on the deflector to direct the flow before and/or after the feed flow contacts the deflector. The baffle(s) can intercept the full flow, directing one way or split the stream into multiple flows. In another aspect, the baffle(s) do not extend through the full flow as it passes over the deflector.

This allows a portion of the flow to not be directed by the baffle(s). The arrangement would be designed to have more consistent volume across the ‘fan’ flow. In one aspect of the technology, the baffles comprise a rectangular or inverted V-shaped protrusion disposed about a top portion of the deflector. The baffle is oriented in a direction that is parallel to a radial direction measured from the center of the deflector. In another aspect, the baffle is oriented in a direction that ranges between 15 and 45 degrees with respect to an imaginary axis parallel to a radial direction from the center of the deflector. In one aspect, the baffle has a height ranging from 1 to 20 inches and a length ranging from 12 inches to 2-3 feet. In another aspect of the technology, the baffle is sized to have a height that is approximately half the depth of the feed flow along the top surface of the deflector. In this aspect, the flow of the bottom half of the feed is directed by the baffle while the top half moves about the top of the deflector as friction and flow rates dictate. In another aspect, the baffle extends the entire length of the deflector. Meaning, it intercepts the feed flow and directs the feed flow all the way to the outer edge of the deflector.

In one aspect of the technology, one or more protrusions are disposed atop the deflector to slow the flow of the feed slurry in an effort to optimize the flow rate at which the feed slurry flow intercepts the outer wall of the feedwell. In one aspect, the protrusions have a rounded top. In another aspect, the protrusions have a rectangular top.

In one aspect of the technology, there is one or more gaps between the deflector and the drive shaft of a thickener mechanism. Settling vessels have mechanisms to assist in the thickening process that comprise a shaft connecting a drive motor with rake arms and blades that rotates to help transport the settled solids to the discharge nozzles. The technology uses one or more gaps between the deflector and the shaft to allow circulation of flow welling up to pass and be drawn into the fanning flow and help dilute and/or bring solids back to be flocculated. In one aspect, the gap circumscribes the outer edge of the deflector in a continuous manner. In another aspect, a plurality of gaps form a plurality of discontinuous openings between the deflector and the outer wall of the feedwell. In this manner, the amount of slurry in the mixing zone is optimized. In another aspect of the technology, one or more feed pipes entering the feedwell have an outlet below the surface of the slurry. In this aspect, the deflector is also submerged beneath the slurry in the feedwell. The feed pipe is equipped with a plate surrounding the pipe to be located near the slurry surface to prevent vortexes developing and air drawn into the slurry as entrapped air can be detrimental to effective flocculation.

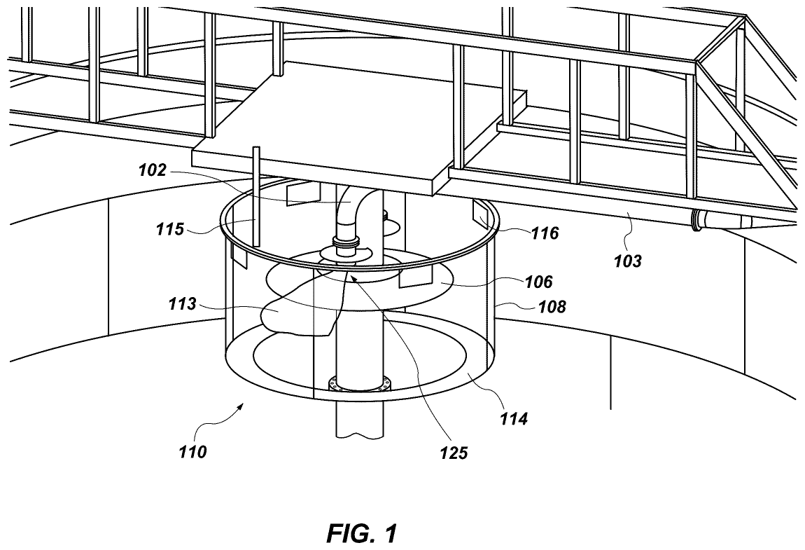

FIG. 1 discloses, in one aspect of the technology a feedwell 110 communicating with a settling vessel as flow leaves the feedwell 110. The technology is a single stage design where the feed enters the feedwell directly. The feed flow, pipe 103 enters the feedwell in a general downward direction 102. The feed pipe transition from relatively horizontal to generally downward direction comprises a 90-degree elbow, or any other method generally used in the industry. The flow is fed downwardly into the feedwell. The feedwell is equipped with a deflector 106. The feed flow is sent toward the deflector 106. The deflector 106 intercepts the majority or substantially all of slurry feed flow after the flow leaves the pipe outlet 125. The flow is directed toward the feedwell outer wall 108 by the deflector 106. Contact with the defector 106 gives the feed flow a significant outwardly expanding or fan-shaped flow pattern 113. As the feed flow contacts the outer wall 108, the feed flow divides with a portion rising up the outer wall and portion going down the outer wall.

In one aspect of the technology, the outer feedwell wall is equipped with a shelf 114 that extends in toward the center. The shelf has a donut shape with a central hole through which the flocculated feed solids enter the settling vessel. The downward flow along the outer wall contacts the shelf causing the flow to change direction with part of the flow directed toward the center of the vessel. The pattern results in recirculation pattern. The mixing zone resulting from this flow pattern provides mixing required for flocculation. The feedwell is equipped to deliver flocculant solution through a pipe 115 and dilution flow 116 through either self-dilution (i.e., no mechanical assistance) or forced dilution (i.e., involving mechanical assistance). In one aspect of the technology, the slurry feed pipe outlet 125 is generally submerged below the slurry level inside the feedwell, though in other aspects the slurry feed pipe outlet is disposed above the slurry level. Vortices plates are attached to the feed pipe to aid in suppression the development of vortex flow patterns that may introduce air.

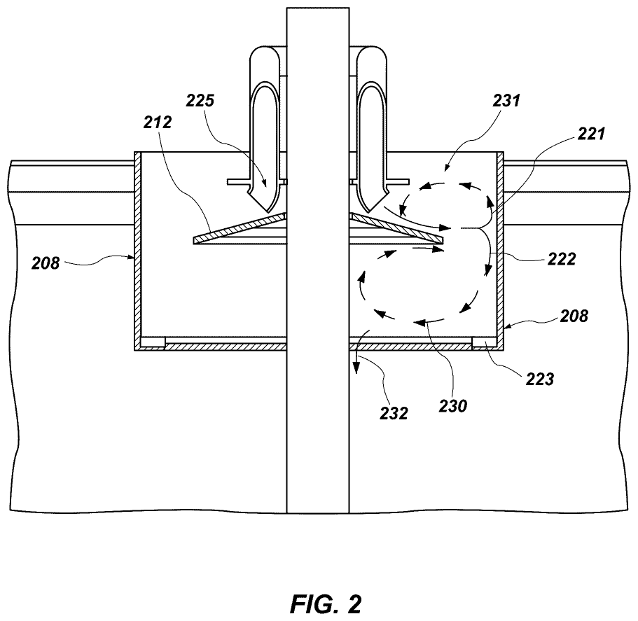

Referring to FIG. 2, it is believed that the flow resulting from the use of the technology feedwell design is illustrated. As the slurry feed flow leaves the feed pipe outlet 225 it changes direction as determined by the deflector 212. In one aspect, the feed flow spreads, in 360 degrees or less out (i.e., in a fan shape) on the deflector 212. The flow pattern leaving the deflector is approximately a ‘fan’ shape. The flow leaving the deflector has a significant flow across the fan spread toward the outer wall 208 of the feedwell. The flow contacts the feedwell outer wall 208 at a reduced velocity, due to the resistance of movement through the slurry in the feedwell. Upon reaching the wall the velocity is slower when compared to that observed at the feed pipe outlet 225. The change of direction of the feed flow in a relatively fanning shape prevents the feedwell issue of short circuiting. The active mixing zone is across the full fan flow giving a large optimal mixing for flocculation of the solids. When the feed flow contacts the feedwell outer wall 208, the flow splits with a portion directed upward 221 and a portion directed downward 222. The flow pattern provides additional mixing as the slurry returns to the mixing zone. The feedwell outer wall connects a shelf 223 generally at a level below the point where the fanning flow contacts the feedwell wall. The downward directed portion of the flow 222 travels toward the shelf 223 and changes direction toward the center and establishes a recirculating flow pattern with a portion of the flow rising to a first mixing zone 231. The upward flow 221 wells up upon reaching the surface of the slurry inside the feedwell and then returns down to create a second mixing zone 230. Floccular flow 232 exits the feedwell.

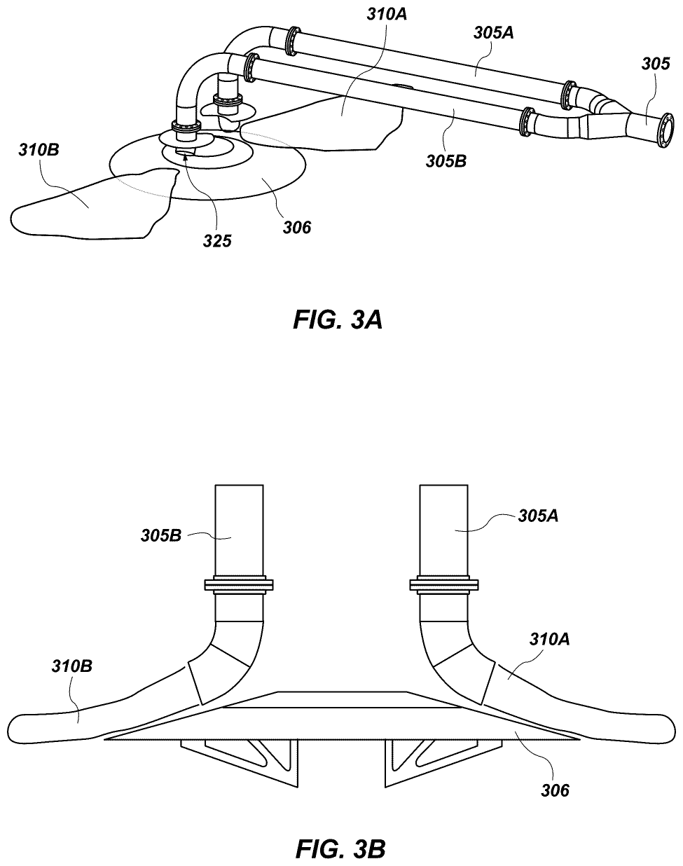

With reference to FIGS. 3A and 3B, in another aspect of the technology, a slurry feed stream is transported to the feedwell in a feed pipe 305 or launder. The feed pipe 305 is split into more than one feed line. In one aspect, the feed pipe 305 is split into two feed lines 305A and 305B. The feed flow is split relatively even between the two lines and transitioned to a relatively downward direction. The flow from each pipe (305A, 305B) through each pipe outlet 325 is directed toward deflector 306. Each of the pipes can be sent to the same deflector position and sized to intercept both flows. The flow from each feed pipe is directed by the deflector 306 to the feedwell outer wall in a generally fan shape 310. Advantageously, this flow pattern assists in the creation of a desired mixing area at the feed wall. The multiple feed pipe split increases the mixing area by directing the ‘fan’ flow to the quadrant where the feed pipe split enters the feedwell.

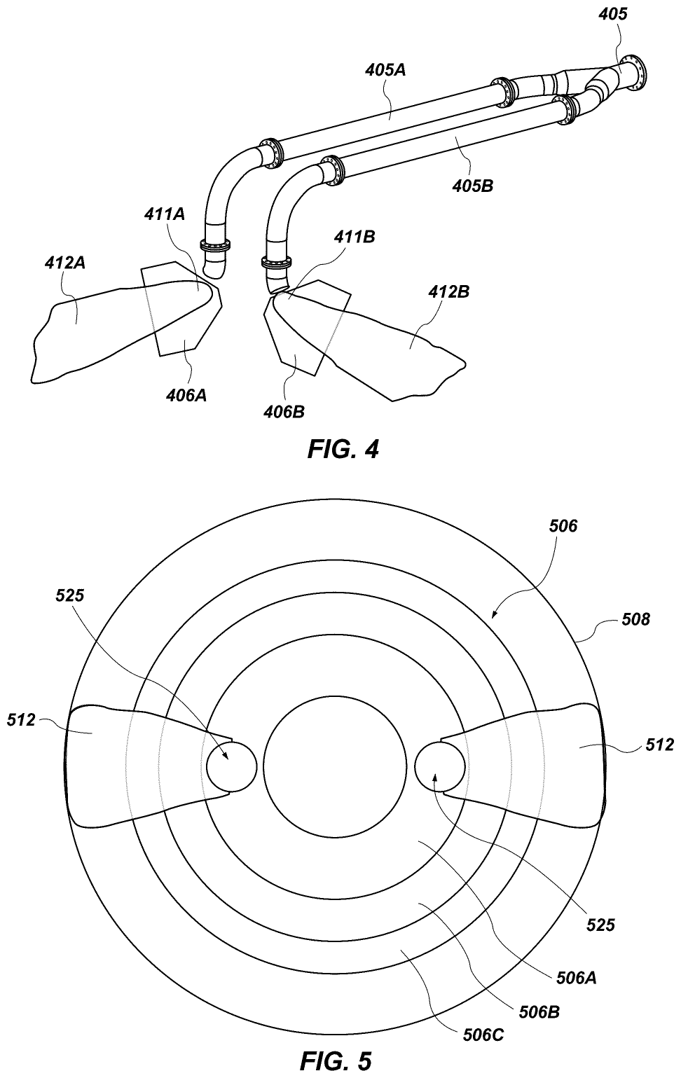

Referring to FIG. 4, one aspect of the technology comprises a feed pipe 405 that has been split into the two feed lines 405A, 405B, each feed line can be directed to separate deflectors 406A, 406B. Each deflector will intercept the feed flow 411A, 411B and direct each flow to a generally fan-shaped flow 412A, 412B directed to the feedwell outer wall.

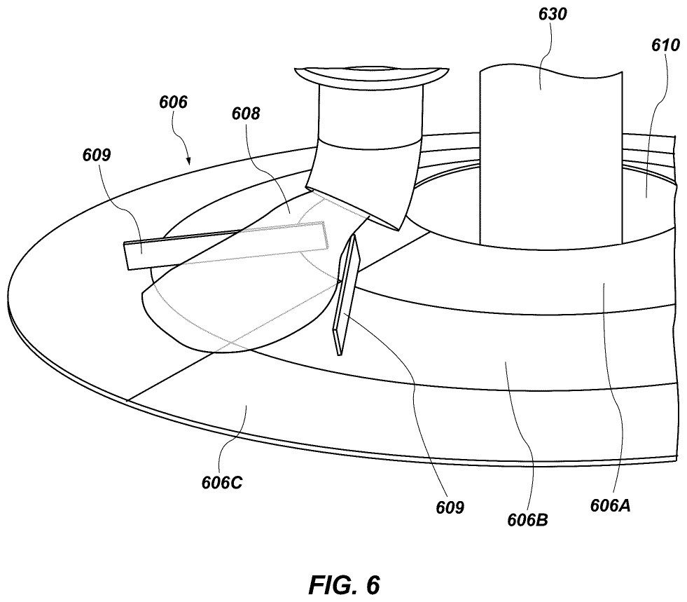

With reference to FIG. 5, in another aspect of the technology, the feedwell is equipped with a deflector 506 that intercepts the feed flow exiting from the pipe(s) outlets 525 and directs the flow into a fan-shape 512. The downward facing feed pipe is angled to a larger angle measured down the deflector 506. This arrangement provides a wider fan flow pattern 512 directed to the feedwell outer wall 508. Directing the flow at a smaller angle onto the deflector surface produces a narrower fan with the quantity of flow significantly less on the outer portion of the fan flow compared to the middle of the fan flow. The angle of the flow as it contacts the deflector can be optimized for improved mixing. For example, in one aspect of the technology, a first section of the deflector 506A comprises a first angle ranging from 25 to 40 degrees, a second section 506B comprises a second angle ranging from 15 to 25 degrees, and a third section 506C comprises a third angle ranging from 0 to 15 degrees. Advantageously, the different angles help control the velocity of and fanning spread of the feed flow as it exits the feed pipe outlet and is intercepted by the deflector 506. More or less than three sections may be used as suits a particular purpose. In another aspect of the technology, the surface of the deflector 506 is curvilinear and comprises a continuous radius of curvature. In another aspect, the deflector 506 is curvilinear an comprises a discontinuous radius of curvature. Meaning, the radius of curvature near a top of the deflector is greater than the radius of curvature near the bottom of the deflector. With reference to FIG. 6, in another aspect of the technology, the deflector 606 is provided to intercept the flow and transition it to a generally fan-shaped flow pattern. The deflector can be equipped with baffle(s) 609 to aid in directing the feed flow as desired. The baffle(s) 609 are used to direct substantially the full flow in one direction, or to be split into two or more streams. The baffle(s) 609 are designed to better manage the shape of the feed flow being directed to the feedwell outer wall 607. The baffle(s) 609 can be designed to intercept the full feed flow 608 or be designed to allow a portion of the feed flow to pass by the baffle(s) 609 without being significantly affected by the baffle(s) 609. In one aspect of the technology, one or more gap(s) 610 are disposed between the deflector 606 and the drive shaft 630. The gap(s) 610 provide a path for the recirculating flow from below, to rise, collecting above the deflector 606 to join the feed flow. The recirculation flow provides dilution water and the potential to flocculate any residual particles that might be in the recirculating flow. In one aspect of the technology, deflector 606 comprises one or more sections 606A, 606B, and 606C. Each of the sections comprises a different angle with respect to the horizontal surface of the slurry level within the feedwell. In one aspect, a first section 606A comprises a first angle ranging from 30 to 45 degrees, a second section 606B comprises a second angle ranging from 20 to 30 degrees, and a third section 606C comprises a third angle ranging from 5 to 20 degrees. Advantageously, the different angles help control the velocity of and fanning spread of the feed flow as it exits the feed pipe outlet and is intercepted by the deflector 606.

In another aspect, the slurry feed pipe outlet is submerged beneath the slurry in the feedwell. It is believed that submerging the pipe outlet(s) helps reduce air entrapment that can be detrimental to flocculation. Another benefit is to reduce any part of the slurry feed flow from skimming across the surface of the feedwell slurry which will reduce the amount for mixing when reaching the feedwell outer wall. In this aspect, the deflector is submerged below the pipe outlet to direct the flow outward in a generally fan-shaped pattern toward the outer wall. In this aspect, submerging the full feed flow produces a relatively even flow sent to the feedwell wall, and creates an additional mixing zone above deflector.

The foregoing detailed description describes the technology with reference to specific exemplary aspects. However, it will be appreciated that various modifications and changes can be made without departing from the scope of the present technology as set forth in the appended claims. The detailed description and accompanying drawings are to be regarded as merely illustrative, rather than as restrictive, and all such modifications, combination of features, or changes, if any, are intended to fall within the scope of the present technology as described and set forth herein. In addition, while specific features are shown or described as used in connection with particular aspects of the technology, it is understood that different features may be combined and used with different aspects. Likewise, numerous features from various aspects of the technology described herein may be combined in any number of variations as suits a particular purpose.

More specifically, while illustrative exemplary aspects of the technology have been described herein, the present technology is not limited to these aspects, but includes any and all aspects having modifications, omissions, combinations (e.g., of aspects across various embodiments), adaptations and/or alterations as would be appreciated by those in the art based on the foregoing detailed description. The limitations in the claims are to be interpreted broadly based on the language employed in the claims and not limited to examples described in the foregoing detailed description or during the prosecution of the application, which examples are to be construed as non-exclusive. For example, in the present disclosure, the term “preferably” is non-exclusive where it is intended to mean “preferably, but not limited to.” Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus-function are expressly recited in the description herein. Accordingly, the scope of the technology should be determined solely by the appended claims and their legal equivalents, rather than by the descriptions and examples given above.

1. A settling vessel, comprising:
a feedwell configured to receive slurry feed from a feed line, the feedwell comprising an outer wall;
wherein the feedline comprises an outlet configured to propagate a slurry feed stream into the feedwell in a downward direction; and
a deflector disposed beneath the feedline outlet concentric around a center line of the feedwell, the deflector having a substantially flat upper surface; and
a gap disposed about an outer edge of the deflector.

2. The settling vessel of claim 1, where the outer wall of the feedwell comprises a shelf that extends inward from the outer wall towards the center of the feedwell, the shelf being disposed below the deflector.

3. The settling vessel of claim 2, wherein the deflector comprises a cone shape.

4. The settling vessel of claim 1, wherein the feed line comprises a plurality of feed lines each having an outlet oriented in a downward direction.

5. The settling vessel of claim 4, comprising a plurality of deflectors, each one of the plurality of deflectors disposed beneath one of the plurality of feed lines.

6. The settling vessel of claim 1, further comprising one or more baffles disposed about a top of the deflector within a path of the slurry feed stream.

7. The settling vessel of claim 1, wherein the outlet of the slurry feed line is disposed beneath a feedwell slurry level within the feedwell.

8. The settling vessel of claim 1, further comprising a shaft disposed about a center of the feedwell, the deflector circumscribing the shaft.

9. The settling vessel of claim 8, comprising one or more gaps between an inner edge of the deflector and an outer wall of the shaft.

10. A method of distributing feed flow into a slurry feedwell, comprising:
providing a slurry feed flow in at least a partially downward direction toward an internal volume of a feedwell at a predetermined flow rate;
receiving the slurry feed flow about a top of a deflector disposed within the feedwell, wherein the deflector comprises a downwardly sloping top surface extending from an internal portion of the feedwell towards an outer wall of the feedwell,
wherein as the slurry feed flow contacts the top surface of the deflector, momentum of the slurry feed flow causes the slurry feed flow to travel downwardly on the deflector towards the outer wall of the feedwell, the slurry feed flow spreading out over the top of the deflector in a fan-like shape.

11. The method of claim 10, wherein the deflector and the outer wall of the feedwell are concentric.

12. The method of claim 10, wherein the top of the deflector is submerged beneath a feedwell slurry circulating within the feedwell.

13. The method of claim 10, further comprising the step of positioning the deflector within the feedwell such that one or more gaps is disposed between an outer edge of the deflector and the outer wall.

14. The method of claim 13, wherein a first portion of the slurry feed flow contacts the outer wall and is propagated upward within the feedwell, towards a center of the feedwell, back down on a top of the deflector, and back again in contact with the outer wall creating a first mixing zone.

15. The method of claim 14, wherein a second portion of the slurry feed flow contacts the outer wall and is propagated downward within the feedwell, towards the center of the feedwell, and back again toward the outer wall of the feedwell creating a second mixing zone.

16. The method of claim 10, further comprising adding a quantity of flocculant to the feedwell slurry to induce flocculation of solids within the feedwell slurry.

17. The method of claim 16, further comprising removing flocculated solids that have settled to a bottom portion of the feedwell.

18. A system for flocculating solids in a waste-water flow, comprising:
a single-stage settling vessel with a feedwell configured to receive a slurry feed stream flow therein and mix the slurry feed stream flow with a feedwell slurry at a predetermined rate, the slurry feed stream flow being delivered to the feedwell through a slurry feed outlet configured to propagate a portion of the slurry feed stream flow in a downward direction;
a deflector disposed within the feedwell and beneath the slurry feed outlet, the deflector comprising a downwardly sloping top surface configured to receive the slurry feed stream flow thereon and direct the slurry feed stream towards an outer wall of the feedwell;
a first gap disposed between an outer edge of the deflector and the outer wall of the feedwell, said first gap circumscribing the outer edge of the deflector;
a second gap disposed between a center shaft of the feedwell and an inner edge of the deflector, said second gap inscribing the inner edge of the deflector,
a volume of flocculant within the feedwell slurry for flocculating solids within the feedwell slurry;
an opening disposed about a bottom portion of the feedwell for removing solids that have flocculated and settled to the bottom portion of the feedwell.

19. The system of claim 18, further comprising one or more baffles disposed about the top of the deflector, the baffles configured to manage the outward spread of the slurry feed flow about the top surface of the deflector.

20. The system of claim 18, further comprising a plurality of slurry feed outlets and a plurality of deflectors, wherein each one of the plurality of slurry feed outlets is disposed above a different one of the plurality of deflectors.
